(19) United States
(12) Patent Application Publication
(10) Pub. No.: US 2009/0059233 A1
(43) Pub. Date: Mar. 5, 2009

(54) MICROFIBER PHOTONIC DEVICES IMMERSED IN A LIQUID MATERIAL

(75) Inventor: Mikhail SUMETSKY, Bridgewater, NJ (US)

Correspondence Address: OBLON, SPIVAK, MCCLELLAND MAIER & NEUSTADT, P.C., 1940 DUKE STREET, ALEXANDRIA, VA, 22314, US

(73) Assignee: FURUKAWA ELECTRIC NORTH AMERICA, INC. (FENA), Norcross, GA (US)

(21) Appl. No.: 11/871,547

(22) Filed: Oct. 12, 2007

Related U.S. Application Data
(60) Provisional application No. 60/968,775, filed on Aug. 29, 2007.

(51) Int. Cl. G01N 21/59; G02B 6/26

(52) U.S. Cl. 356/436; 385/28

(57) ABSTRACT

An electromagnetic device, including: a microfiber or other optical waveguide configured to guide an electromagnetic field output by an electromagnetic field source, the microfiber or other optical waveguide having a diameter that is less than or on an order of a wavelength of the electromagnetic field output by the electromagnetic field source; and a first optical material in contact with the microfiber or other optical waveguide, wherein at least a contact region of the microfiber or other optical waveguide and the first optical material is immersed in a liquid or cured dielectric that has an index of refraction less than the index of refraction of the microfiber or other optical waveguide.

### CROSS REFERENCE TO RELATED APPLICATIONS

The present application claims the benefit under 35 U.S.C. §119(e) to Provisional Application Ser. No. 60/968,775, filed on Aug. 29, 2007, which is hereby incorporated by reference in its entirety. The present application incorporates by reference U.S. Application Ser. No. 60/555,994, filed Mar. 24, 2004, and U.S. Pat. No. 7,266,259.

### BACKGROUND OF THE INVENTION

1. Field of the Invention

The present invention generally relates to electromagnetic devices, and more particularly relates to an electromagnetic device immersed in a liquid material.

The present invention includes the use of various technologies referenced and described in the documents identified in the following LIST OF REFERENCES:

### LIST OF REFERENCES

[1] M. Sumetsky, “Optical fiber microcoil resonator,” Opt. Express 12, 2303 (2004);

[2] M. Sumetsky, Y. Dulashko, and M. Fishteyn, “Demonstration of a multi-turn microfiber coil resonator,” post deadline paper PDP46, OFC conference (2007);

[3] L. M. Tong, J. Y. Lou, R. R. Gattass, S. L He, X. W. Chen, L. Liu, and Mazur E, “Assembly of silica nanowires on silica aerogels for microphotonic devices,” Nano Lett. 5, 259 (2005);

[4] I. M. White, H. Oveys, and X. Fan, “Liquid Core Optical Ring Resonator Sensors,” Opt. Lett., 31, 1319-1321 (2006);

[5] H. S. Mackenzie and F. P. Payne, “Evanescent field amplification in a tapered single-mode fibre,” Electron. Lett. 26, 130-132 (1990);

[6] G. J. Pendock, H. S. MacKenzie, and F. P. Payne, “Dye lasers using tapered optical fibers,” Appl. Opt. 32, 5236-5242 (1993);

[7] P. Polynkin, A. Polynkin, N. Peyghambarian, and M. Mansuripur, “Evanescent field-based optical fiber sensing device for measuring the refractive index of liquids in microfluidic channels,” Opt. Lett. 30, 1273-1275 (2005); and

[8] M. Sumetsky, “Uniform coil optical resonator and waveguide: transmission spectrum, eigenmodes, and dispersion relation,” Opt. Express 13, 4331-4340 (2005).

Each reference in the LIST OF REFERENCES is hereby incorporated by reference in its entirety.

2. Description of the Related Art

Microfiber (MF) photonics is a field of optics exploring devices fabricated from microfibers. Recently, there has been an increased interest in optical devices fabricated with microfibers having a diameter of approximately 0.1 to a few microns, which are usually drawn from standard optical fibers. An optical MF may be created by drawing a conventional telecom fiber down to a diameter of approximately 1 micron, or comparable to a wavelength of propagating light. Very small transmission losses of MFs have been demonstrated, which make them potential basic elements for miniature photonic devices.

However, conventional optical MFs suffer from several problems, which cause degradation in the quality of results achieved by miniature photonic devices incorporating the optical MFs. A free standing microfiber loop is fragile and subject to surface contamination and corrosion, which results in degraded transmission characteristics. Furthermore, operation in free space does not allow for the creation of a high quality-factor multi-turn microfiber coil resonator (MCR), which is a building block of resonator devices.

Furthermore, the contact between a MF and a substrate introduces light scattering and degrades the performance of an optical device including the MF and substrate. Scattering loss grows with the difference between the refractive index of air surrounding the MF and the refractive index of the substrate.

### SUMMARY OF THE INVENTION

Accordingly, one object of the present application is to address at least some of the above described and/or other problems of conventional devices.

In one embodiments, an electromagnetic device, includes: a microfiber or other optical waveguide configured to guide electromagnetic field output by an electromagnetic field source, the microfiber or other optical waveguide having a diameter that is less than or on an order of a wavelength of the electromagnetic field output by the electromagnetic field source; and a first optical material in contact with the microfiber or other optical waveguide, wherein at least a contact region of the microfiber or other optical waveguide and the first optical material is immersed in a liquid or cured or solidified dielectric that has an index of refraction less than the index of refraction of the microfiber or other optical waveguide.

In another embodiment, the electromagnetic device further includes: a second optical material electromagnetically coupled to the microfiber or other optical waveguide, wherein the second optical material is at least partially immersed in the liquid or cured dielectric.

In another embodiment of the electromagnetic device, the second optical material is one of a dielectric sphere, cylinder, and disk.

In another embodiment of the electromagnetic device, the wavelength is on an order of a micrometer.

In another embodiment of the electromagnetic device, the first optical material is an optical cylinder, and the microfiber or other optical waveguide is disposed to be wrapped around the optical cylinder.

In another embodiment of the electromagnetic device, the first optical material is an optical cylinder configured to use whispering gallery modes to sense characteristics of a medium.

In another embodiment of the electromagnetic device, the optical cylinder has a wall with a thickness on an order of the wavelength of the electromagnetic field.

In another embodiment of the electromagnetic device, the microfiber or other optical waveguide and first optical material are configured to output a signal to an analyzer to determine a physical, chemical, or biological characteristic of a medium.

In another embodiment of the electromagnetic device, the first optical material includes a channel for a liquid or gas.

In another embodiment of the electromagnetic device, the channel is an etched channel.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a non-limiting example of an electromagnetic device embodying the present invention;

FIG. 2 is a non-limiting example of a microfiber coil resonator (MCR) immersed in a liquid or cured optical material;

FIG. 3 is a non-limiting embodiment of a setup for manufacturing the MCR shown in FIG. 2;

FIGS. 4A-4C show an non-limiting example of a microfiber-cylinder and/or microfiber-cylindrical capillary sensors immersed in a liquid or in a cured optical material; and

FIG. 5 is a non-limiting example of a microfiber included in a sensing structure.

### DETAILED DESCRIPTION OF THE EMBODIMENTS

Referring now to the drawings, wherein like reference numerals designate identical or corresponding parts throughout the several views.

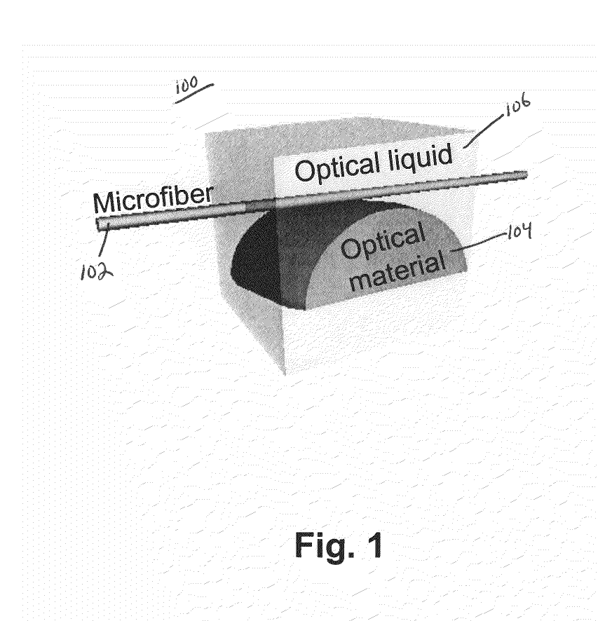

FIG. 1 shows a non-limiting example of an electromagnetic device 100. Electromagnetic device 100 includes microfiber 102, another optical material 104, and an optical liquid 106. The another optical material includes, but is not limited to, a sphere (i.e., a microsphere), a cylinder (i.e., a microcylinder), or a disk (i.e., a microdisk). The MF 102 is configured to perform coupling of light into microspheres and microcylinders. The another optical material can also be configured to work as cavities within excited whispering gallery modes (WGMs), which will be discussed in further detail below. The microfiber and the other optical material can consist of glass (including compound glass), a polymer, and other solid optical materials, which transmit and/or attenuate light. The optical liquid may be composed of a liquid polymer, any kind of a matching optical liquid, and other liquid optical material, which transmit and/or attenuate light.

As shown in FIG. 1, the MF 102 and the optical material 104 are both immersed in the optical liquid 106. The role of the optical liquid is to protect the area of contact between the MF and the optical material from corrosion and contamination. At the same time, the liquid is used to adjust light coupling between the MF and the optical material by choosing the liquid with the appropriate refractive index. The entire structure does not have to be immersed in the optical liquid. Advantageously, a contact region between the MF 102 and the optical material 104 may be immersed in the optical liquid 106. The MF 102 and the optical material are not necessarily in direct contact after the immersion in the optical liquid. Rather, some amount of the optical liquid may separate the MF 102 and optical material 104. As used herein, “contact” includes direct contact or indirect contact where the items still maintain a close proximity with respect to each other.

Optical material 106 may be solidified by curing. By curing and solidifying the optical material, the robustness of the electromagnetic device shown in FIG. 1 is increased, when compared to conventional optical devices.

Furthermore, by immersing the MF 102 and the optical material 104 in the optical liquid 106, the electromagnetic device is no longer in free space. Thus, there is no corrosion or contamination by the air.

Conventional thinking may consider MF photonics to be a step backwards, when compared to photonics based on lithographic technology such as planar lightwave circuits. As an analogy, this may be thought of as a comparison between wired circuits and lithographically-fabricated waveguides. However, MFs have several advantages compared to lithographically-fabricated waveguides, which include: (1) MFs have significantly smaller losses for a given index contrast, enabling lower insertion loss or more complex structures, (2) the potential to form micro-assemblies in 3D by wrapping MFs around central optical rods which eventually may be used to create MF devices which are significantly more compact than those fabricated lithographically, and (3) MFs have a significantly higher index contrast, allowing optical properties which cannot be accessed in conventional lithographic circuits. Furthermore, some MF-based devices possess unique functionalities, which are not possible or much harder to achieve by other means. For example, an evanescent field of a subwavelength diameter MF has a cylindrical shape and is distributed along a much larger surface area than the evanescent field of a planar waveguide. The latter property is important for sensing applications where the accuracy of detection is proportional to the surface area, along which sensing is performed.

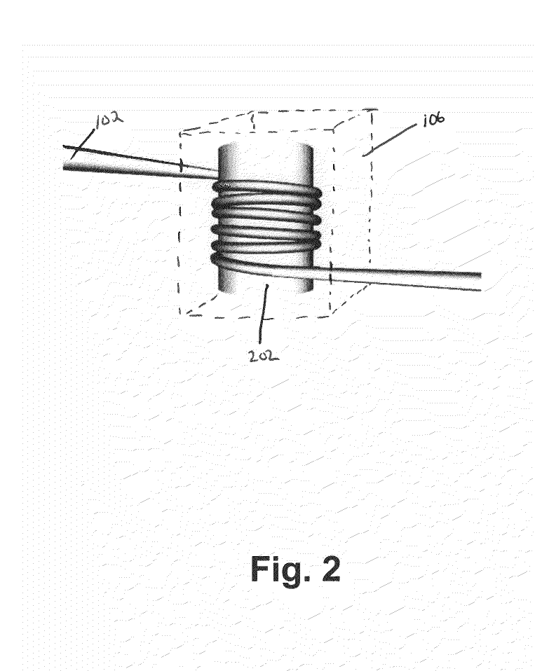

FIG. 2 is an example of a microfiber coil resonator 200 immersed in a liquid or cured optical material. A photonic circuit may be created by wrapping microfiber 102 onto a central rod 202. Such a structure is known as a microfiber coil resonator (MCR). In the embodiment shown in FIG. 2, the MCR 200 is immersed in an optical liquid 106. As discussed above, the optical liquid may be solidified by curing.

At resonance frequencies, light propagating along the MCR can be trapped or delayed within the coil due to inter-turn coupling. Advantages of MCR photonic circuits, as compared to conventional lithographically fabricated photonic circuits, include natural input and output connections, the possibility of a compact 3D assembly, extremely high index contrast, and atomically-smooth waveguide surfaces, all in a single continuous fiber. Furthermore, the MCR device shown in FIG. 2 can have a complex transmission spectrum, which is much harder to achieve with the planar ring resonator circuits. In particular, a MF coil resonator can perform a function of a dispersion compensator, similar to a planar sequence of ring resonators, being, though, much more compact in dimensions.

As examples, a multi-turn coil microfiber can serve as a miniature broadband delay line, and a sequence of loop resonators illustrated in FIG. 2 can perform the function of a multi-channel dispersion compensator analogous to the planar sequence of ring resonators. In addition, an MCR immersed in a liquid acts as a very responsive sensor of the properties of an adjacent medium.

An MCR plays the same role as a ring resonator (or a sequence of ring resonators) in planar photonic circuits. The straightforward wrapping of a microfiber around a rod in air encounters several significant problems resulting in considerable propagation loss. Among these problems are (i) light scattering and absorption due to contamination of the microfiber and rod surfaces and (ii) light scattering at the discontinuities of the microfiber-rod contact line (in particular, at the first and last contact points). These problems can be avoided if the microfiber manipulation is performed in an environment having a refractive index equal to the refractive index of the rod. Thus, index of refraction of the optical liquid 106 that surrounds the contact region of rod 202 and MF 102 is the same as the index of refraction for rod 202. In this case, the microfiber 102 does not “see” the rod 202 optically. Thus, FIG. 2 shows a high-Q MCR. The Q-factor of this device may range from relatively small ˜10³ to very high ˜10⁹.

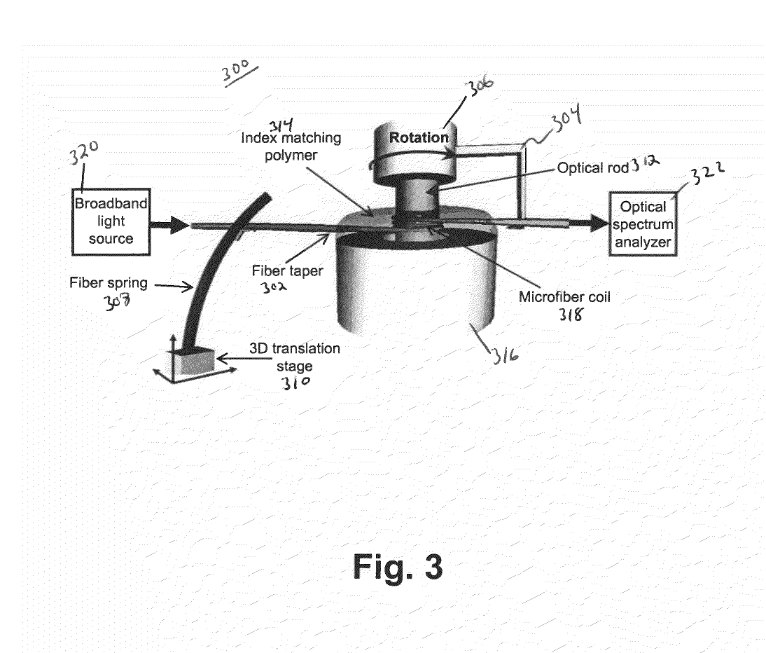

FIG. 3 shows a setup 300 for fabricating the MCR shown in FIG. 2. A biconical taper 302 with a microfiber waist is drawn from a single mode telecom fiber. One of the taper ends is glued to the Γ-shaped leg 304, which is fixed at the rotating shaft 306. The other end of the taper 302 is fixed at the fiber spring 308, which maintains the taper in a lightly strained condition. The introduced stress and position of the spring 308 is varied with a 3D translation stage 310. A rod 312 is fixed at the end of the rotating shaft and is coated with a film of cured polymer with a refractive index that is smaller than the refractive index of silica microfiber. The microfiber 302 and rod 312 are immersed in a pool of the same uncured liquid polymer 314 contained on a round substrate 316. The convex meniscus at the pool edges allows free entrance of the microfiber 302 into the liquid 314. The microfiber 302 can be wrapped onto the rod 312 by rotating the shaft 306 and the Γ-shaped leg 304.

The MF 302 and the rod 312 may be immersed in the optical liquid 314 before they are brought into contact with each other, or the MF 302 and the rod 312 may be immersed in the optical liquid 314 after they are brought into contact with each other.

One end of the taper is connected to a broadband light source 320 and the other to an optical spectrum analyzer (OSA) 322. The OSA 322 monitors the transmission spectrum of the MCR during the wrapping process.

An MCR fabricated in a liquid is secured from surface contamination and maintains its transmission characteristics provided the device is temperature stabilized. Furthermore, the liquid environment can be solidified by curing, which makes the device all-solid and, therefore, more robust.

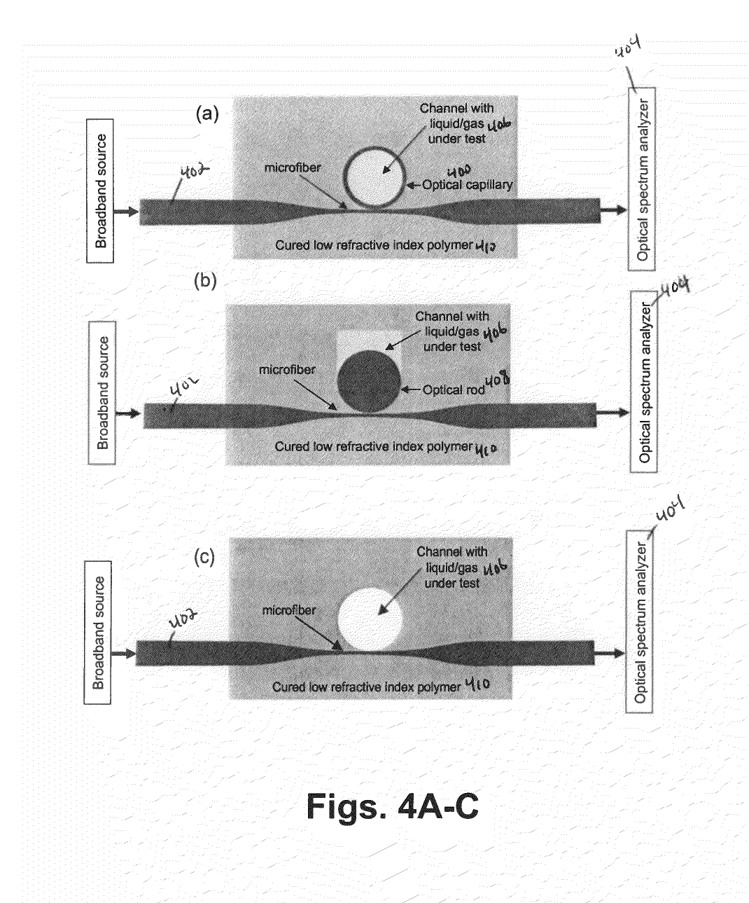

FIGS. 4A-4C show a microfiber-cylinder and/or microfiber-cylindrical capillary sensors immersed in a liquid or in a cured optical material.

FIG. 4A is an example of a liquid core whispering gallery mode (WGM) optical sensor, which has been immersed in a cured low refractive index polymer. Whispering gallery modes occur at particular resonant wavelengths confined to a cylindrical or spherical volume with an index of refraction greater than or equal to the medium surrounding it. The WGM optical sensor consists of an optical capillary 400 coupled to a MF 402 or an optical waveguide. The index of refraction of the polymer is less than the index of refraction of the capillary. The optical capillary 400 is made of glass, and is slightly larger than the MF. The transmission spectrum of WGMs is monitored by an OSA 404. If the wall of the capillary are thin enough (i.e., a few microns), the WGM transmission spectrum can detect changes that occur along the internal surface of the capillary.

The devices shown in FIGS. 4A-4C may be used as a chemical and biological sensor. The optical properties of the light change depending on the characteristics of the liquid/gas under test 406. Sensitivity of the device shown in FIG. 4A increases by decreasing the capillary 400 wall thickness.

In free space, very thin capillaries become very fragile. In order to make this device more robust and applicable for practical sensing, it immersed into a cured low-index polymer 410 as is illustrated in FIG. 4A. After the polymer is solidified by curing, the capillary is fixed in a solid environment and is no longer fragile. Furthermore, after solidification of the polymer, the capillary wall can be further thinned with etching. The etching can be performed using, e.g. an HF solution, running inside the capillary. Eventually, the wall of the capillary can be removed completely, as depicted in FIG. 4C.

One of the problems in the manufacture of conventional liquid core WGM sensors is fabrication of optical capillary with very thin wall having a thickness of about 1 micron. This problem can be avoided in the design of the evanescent field WGM sensor illustrated in FIG. 4B. In this sensor, a MF excites the WGM modes in the optical cylinder. The optical sensor may be solid glass rod 408. The sensor is immersed into a cured low-index polymer and contains a channel 406 for the liquid under test. Variation of the refractive index of this liquid is determined by the change in spectrum of the WGMs, which is monitored by an OSA as illustrated in FIG. 4B. In order to increase the quality factor of WGMs, the refractive index of the polymer can be matched to the refractive index of the tested liquid.

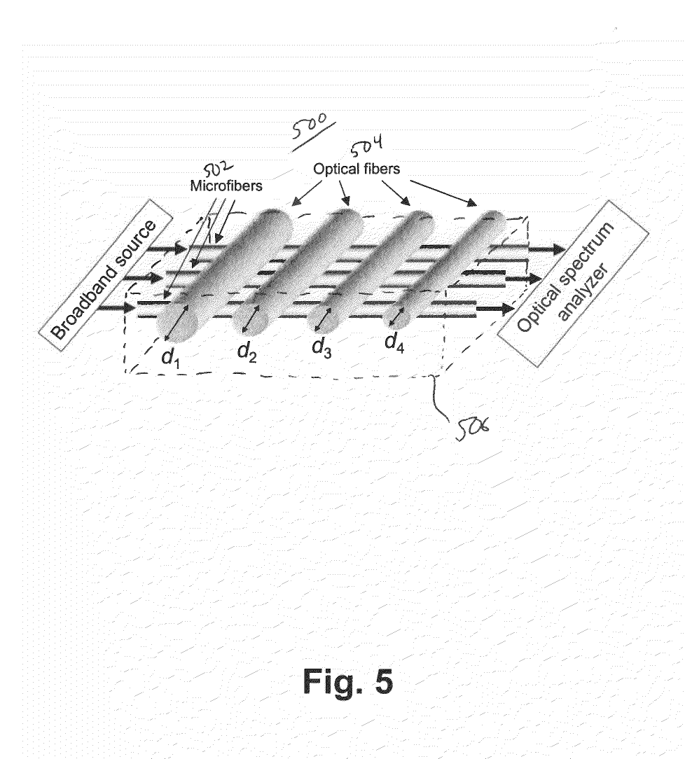

The MFs, optical cylinders, disks, and microspheres can be assembled in more complex multifunctional sensing structures. An example of one of the more complex structures is illustrated in FIG. 5. FIG. 5 shows a matrix 500 of parallel MFs 502 which are in touch with parallel optical microcylinders 504. The MFs 502 and microcylinders 504 are positioned normal to each other. Each of the MF 502 excites WGMs in each of the cylinders 504 similar to as it was described above. The transmission spectrum of each MF 502 contains resonances from WGMs excited at the intersection of the MF 502 with each of the cylinders 504. If the cylinders 504 are uniform in diameter, it is not possible to identify the changes in a certain cylinder 504 from the MF transmission spectrum. Therefore, it is supposed that the diameters of the cylinders, d₁-d₄, are slightly different from each other. Then, the contributions to transmission spectrum of an individual MF from the cylinders are linear independent. A small change in refractive index localized near an intersection of a certain cylinder with a certain MF will result in a complex linear shift of the transmission spectrum of this cylinder. Due to linear independency, the positions of local changes and their values can be separated and determined.

In order to improve the robustness of this device it can be immersed, completely or partly, in a liquid or in a curable optical material 506. In particular, the top parts of the cylinders 504 can be open to an ambient medium or separated from it by a thin polymer layer. Then this matrix 500 can perform as an evanescent sensor. In particular, the geometry of intersection between a MF 502 and a cylinder 504 can be similar to that shown in FIG. 4B.

The above described embodiments involved using a microfiber as an optical waveguide. However, any other optical waveguide can be used. Examples of other waveguides include a waveguide, which is formed at the surface of an optical material using lithography.

Clearly, numerous modifications and variations of the above-described embodiments are possible in light of the above teachings. It is therefore to be understood that within the scope of the appended claims, the invention may be practiced otherwise than as specifically described herein.

1. An electromagnetic device, comprising:
a microfiber or other optical waveguide configured to guide electromagnetic field output by an electromagnetic field source, the microfiber or other optical waveguide having a diameter that is less than or on an order of a wavelength of the electromagnetic field output by the electromagnetic field source; and
a first optical material in contact with the microfiber or other optical waveguide,
wherein at least a contact region of the microfiber or other optical waveguide and the first optical material is immersed in a liquid or cured or solidified dielectric that has an index of refraction less than an index of refraction of the microfiber or other optical waveguide.

2. The electromagnetic device of claim 1, further comprising:
a second optical material electromagnetically coupled to the microfiber or other optical waveguide,
wherein the second optical material is at least partially immersed in the liquid or cured or solidified dielectric.

3. The electromagnetic device of claim 2, wherein the second optical material is one of a dielectric sphere, cylinder, and disk.

4. The electromagnetic device of claim 1, wherein the wavelength is on an order of a micrometer.

5. The electromagnetic device of claim 1, wherein the first optical material is an optical cylinder, and the microfiber or other optical waveguide is disposed to be wrapped around the optical cylinder.

6. The electromagnetic device of claim 1, wherein the first optical material is an optical cylinder configured to use whispering gallery modes to sense characteristics of a medium.

7. The electromagnetic device of claim 6, wherein the optical cylinder has a wall with a thickness on an order of the wavelength of the electromagnetic field.

8. The electromagnetic device of claim 1, wherein the microfiber or other optical waveguide and first optical material are configured to output a signal to an analyzer to determine a physical, chemical, or biological characteristic of a medium.

9. The electromagnetic device of claim 6, wherein the first optical material includes a channel for a liquid or gas.

10. The electromagnetic device of claim 9, wherein the channel is an etched channel.

11. A system comprising:
a microfiber or other optical waveguide configured to guide an electromagnetic field output by an electromagnetic field source, the microfiber or other optical waveguide having a diameter that is less than or on an order of a wavelength of the electromagnetic field output by the electromagnetic field source;
a first optical material in contact with the microfiber or other optical waveguide,
wherein at least a contact region of the microfiber or other optical waveguide and the first optical material is immersed in a liquid or cured or solidified dielectric that has an index of refraction less than an index of refraction of the microfiber or other optical waveguide;
a light source configured to transmit light through the microfiber or other optical waveguide; and
an analyzer configured to receive the light from the light source and to analyze a spectrum of the light.

12. The system of claim 11, further comprising:
a second optical material electromagnetically coupled to the microfiber or other optical waveguide,
wherein the second optical material is at least partially immersed in the liquid or cured dielectric.

13. The system of claim 11, wherein the first optical material is an optical cylinder, and the microfiber or other optical waveguide is disposed to be wrapped around the optical cylinder.

14. The system of claim 11, wherein the first optical material is an optical cylinder configured to use whispering gallery modes to sense characteristics of a medium.

15. The system of claim 11, wherein the first optical material is an optical cylinder, and the microfiber or other optical waveguide is disposed to be wrapped around the optical cylinder.

16. The system of claim 14, wherein the microfiber or other optical waveguide and first optical material are configured to output a signal to an analyzer to determine a physical, chemical, or biological characteristic of a medium.

17. A method, comprising:
guiding an electromagnetic field output by an electromagnetic field source with a microfiber or other optical waveguide, the microfiber or other optical waveguide having a diameter that is less than or on an order of a wavelength of the electromagnetic field output by the electromagnetic field source, wherein
a first optical material is in contact with the microfiber or other optical waveguide, and
at least a contact region of the microfiber or other optical waveguide and the first optical material is immersed in a liquid, cured or solidified dielectric that has an index of refraction less than an index of refraction of the microfiber or other optical waveguide.

18. The method of claim 17, further comprising:
transmitting the electromagnetic field through the microfiber or other optical waveguide;
receiving the electromagnetic field; and
analyzing a spectrum of the electromagnetic field.

19. The method of claim 17, wherein the guiding further comprises:
guiding the electromagnetic field through the microfiber or other optical waveguide that is wrapped around an optical cylinder.

20. The method of claim 18, wherein the analyzing comprises: using whispering gallery modes to sense characteristics of a medium.
